(19) United States
(12) Patent Application Publication
(10) Pub. No.: US 2007/0049151 A1
(43) Pub. Date: Mar. 1, 2007

(54) Composite cloth

(76) Inventors: Kuang Cheng Chao, Taipei City (TW); Chien Yi Ho, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/209,823

(22) Filed: Aug. 24, 2005

(51) Int. Cl. B32B 5/26; D03D 15/00

(52) U.S. Cl. 442/243; 442/199; 442/239; 442/304; 442/190

(57) ABSTRACT

A composite fabric suitable for use as an electric or electronic apparatus shell after stamping through a heat press is disclosed to include a surface layer, which is a woven fabric made out of soft fibers, and a bottom layer, which is a woven fabric made out of a bi-component yarn, which has a yarn core obtained from high strength fiber and a yarn sheath prepared from low melting point polyester fiber and wound round the yarn core.

### BACKGROUND OF THE INVENTION

1. Field of the Invention

The present invention relates fabrics and more particularly, to a composite cloth, which is practical for use to make a shell for an electric or electronic product to substitute for conventional metal or plastic material.

2. Description of the Related Art

Conventional fabrics are commonly made of woven material and used for making clothes, bags, and etc., for the advantages of soft touch and nice outer looking. A fabric can be made to show a fancy pattern or logo. However, because of the soft characteristic, conventional fabrics cannot be used for making a shell for an electric or electronic product to substitute for metal or plastic material.

### SUMMARY OF THE INVENTION

The present invention has been accomplished under the circumstances in view. It is one object of the present invention to provide a composite cloth, which is practical for use to make a shell for an electric or electronic product to substitute for conventional metal or plastic material. It is another object of the present invention to provide a composite cloth, which is practical for use as a shell for an electric or electronic product to provide a nice touch and quality outer looking. To achieve these and other objects of the present invention, the composite fabric comprises a bottom layer and a surface layer. The surface layer is a woven fabric made out of soft fibers. The bottom layer is a woven fabric made out of a bi-component yarn containing a thermoplastic material having a melting point lower than the surface layer. Further, the bi-component yarn comprises a yarn core obtained from high strength fiber selected from a group of fibers including glass fiber, carbon fiber and high strength polyester fiber, and a yarn sheath prepared from low melting point polyester fiber and wound round the yarn core.

### BRIEF DESCRIPTION OF THE DRAWINGS

FIG. 1 is a schematic drawing showing the structure of a bi-component yarn.

FIG. 2 is a schematic exploded view of a composite cloth according to the present invention.

FIG. 3 is a schematic exploded view of an alternate form of the composite cloth according to the present invention.

FIG. 4 shows one application example of the composite cloth according to the present invention.

FIG. 5 shows another application example of the composite cloth according to the present invention.

FIG. 6 shows still another application example of the composite cloth according to the present invention.

### DETAILED DESCRIPTION OF THE PREFERRED EMBODIMENT

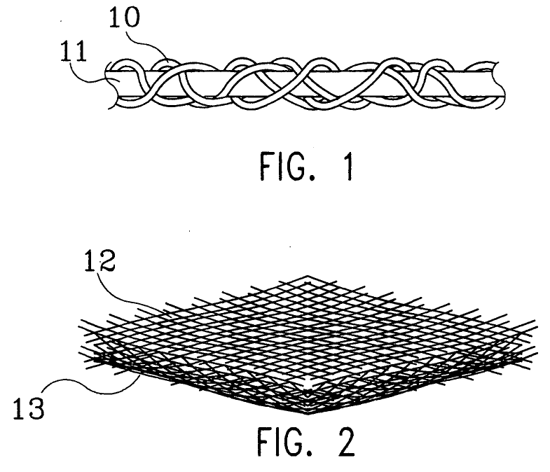

Referring to FIG. 1, a bi-component yarn is shown comprising a yarn core 11 and a yarn sheath 10 wound round the yarn core 11. The yarn core 11 is obtained from high strength fiber (such as glass fiber, carbon bier, or high strength polyester fiber). The yarn sheath 10 is prepared from low melting point polymeric fiber (such as low melting point polyester fiber). The melting point of the yarn sheath 10 is lower than the yarn core 11.

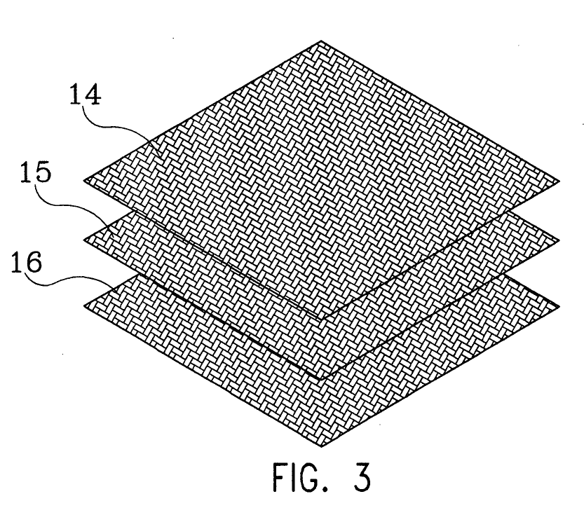

Referring to FIG. 2, a composite cloth in accordance with the present invention comprises a bottom layer 13 and a surface layer 12. The bottom layer 13 is a woven fabric made out of the aforesaid bi-component yarn. The surface layer 12 is a woven fabric made out of any of a variety of conventional yarns for fabric such as cotton yarn, polyester yarn, etc.

A heat press can be used to stamp the composite cloth made according to the present invention into a predetermined shape at a temperature approximately equal to the melting point of the low melting point polymeric fiber of the yarn sheath of the bi-component yarn. After stamping the shape-formed composite cloth has a stiff structure like a plastic shell.

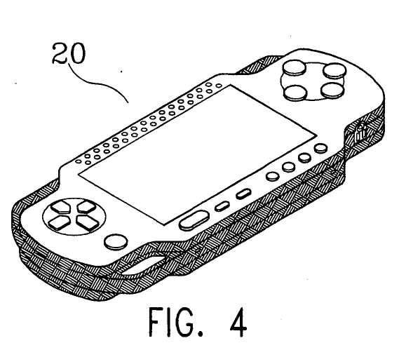

FIG. 3 shows an alternate form of the composite cloth according to the present invention. According to this embodiment, the composite cloth comprises a bottom layer 16, a surface layer 14, and an intermediate reinforcing layer 15 sandwiched between the bottom layer 16 and the surface layer 14. The bottom layer 16 is a woven fabric made out of the aforesaid bi-component yarn. The surface layer 14 is a woven fabric made out of any of a variety of conventional yarns for fabric such as cotton yarn, polyester yarn, etc. The intermediate reinforcing layer 15 is a high strength fabric made out of glass fiber, carbon fiber, or high strength polyester fiber. The melting point of the bottom layer 16 is lower than the surface layer 14 and the intermediate reinforcing layer 15. A heat press can be used to stamp the composite cloth of this alternate form into a predetermined shape at a temperature approximately equal to the melting point of the low melting point polymeric fiber of the yarn sheath of the bi-component yarn of the bottom layer 16. After stamping the shape-formed composite cloth has a stiff structure like a plastic shell.

The composite cloth in accordance with the present invention can be used for making shells for any of a variety of electric home and offices appliances, computers, communication products and any of a variety of consumer electronic products such as palm-top game machine 20, LCD monitor (LCD TV) 30, electronic cooker 50, etc. A product shell made out of the composite cloth has the advantages of nice touch, quality outer looking, stiff structure, and lightweight.

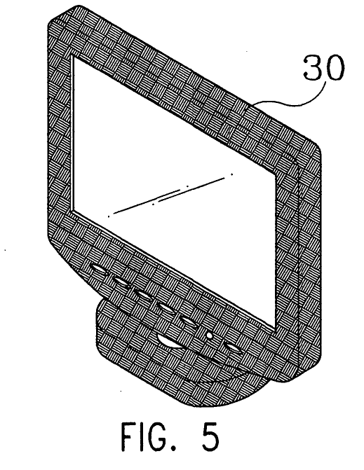

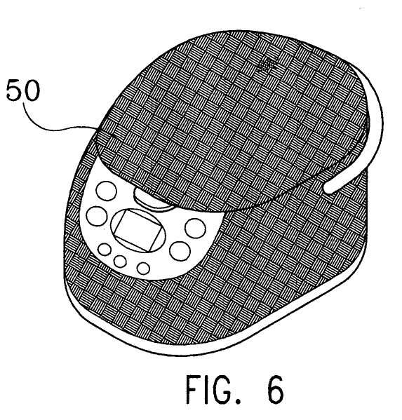

A prototype of thermoplastic fabric has been constructed with the features of FIGS. 1-6. The thermoplastic fabric functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A composite fabric comprising a bottom layer and a surface layer, wherein said surface layer is a woven fabric made out of soft fibers; said bottom layer is a woven fabric made out of a bi-component yarn containing a thermoplastic material having a melting point lower than said surface layer.

2. The composite fabric as claimed in claim 1, wherein said bi-component yarn comprises a yarn core obtained from high strength fiber selected from a group of fibers including glass fiber, carbon fiber and high strength polyester fiber, and a yarn sheath prepared from low melting point polyester fiber and wound round said yarn core.
